(19) United States
(12) Patent Application Publication
(10) Pub. No.: US 2025/0264229 A1
(43) Pub. Date: Aug. 21, 2025

(54) AIR CLEANER

(71) Applicant: Samsung Electronics Co., Ltd., Suwon-si (KR)

(72) Inventors: Junseok KWON, Suwon-si (KR); Nakhyun KIM, Suwon-si (KR); Dohyun KIM, Suwon-si (KR); Juyoung KIM, Suwon-si (KR); Juwan PARK, Suwon-si (KR); Churju LEE, Suwon-si (KR); Hojin LEE, Suwon-si (KR); Seoyoung CHO, Suwon-si (KR); Sunghyun CHUN, Suwon-si (KR)

(21) Appl. No.: 19/054,154

(22) Filed: Feb. 14, 2025

Related U.S. Application Data
(63) Continuation of application No. PCT/KR2025/000469, filed on Jan. 9, 2025.

(30) Foreign Application Priority Data
Feb. 15, 2024 (KR) 10-2024-0021961
May 21, 2024 (KR) 10-2024-0066054

(51) Int. Cl. F24F 1/0073; B01D 46/00; B01D 46/62; F24F 8/108

(52) U.S. Cl. CPC F24F 1/0073; B01D 46/0005; B01D 46/0047; B01D 46/62; F24F 8/108; B01D 2265/021; B01D 2273/30; B01D 2279/50

(57) ABSTRACT

An air cleaner according to an embodiment includes: a housing including an inlet and an outlet; a blower fan; and a filter module including a first plate, a second plate arranged to face the first plate, a first coupling portion formed on at least one of the first plate or the second plate, and a filter arranged between the first plate and the second plate and including a second coupling portion, wherein the filter includes: a first filter portion configured to filter air introduced from the inlet, and separably coupled to the first plate and the second plate, and a second filter portion configured to filter air passed through the first filter portion, and separably coupled to the first plate and the second plate, wherein the first coupling portion and the second coupling portion are separably coupled to each other.

### CROSS-REFERENCE TO RELATED APPLICATIONS

This application is a continuation of International Application No. PCT/KR2025/000469 designating the United States, filed on Jan. 9, 2025, in the Korean Intellectual Property Receiving Office and claiming priority to Korean Patent Application Nos. 10-2024-0021961, filed on Feb. 15, 2024, and 10-2024-0066054, filed on May 21, 2024, in the Korean Intellectual Property Office, the disclosures of each of which are incorporated by reference herein in their entireties.

### BACKGROUND

### Field

The disclosure relates to an air cleaner.

### Description of Related Art

An air conditioner is an apparatus for performing functions, such as air purification, ventilation, humidity control, cooling, or heating in an air-conditioned space, which is equipped with at least one of these functions.

The air conditioner may include an air cleaner for removing pollutants in the air. The air cleaner may remove bacteria, viruses, mold, fine dust, and chemicals that cause bad odors that are present in the air that is drawn in.

The air cleaner may include an inlet for drawing in contaminated air, and may include a blower fan for forming a flow of air.

The air cleaner may include a filter for purifying contaminated indoor air. Air drawn by the air cleaner may be purified into clean air as contaminants are removed from the air while the air passes through the filter, and the purified air may be discharged to the outside through an outlet of the air cleaner.

### SUMMARY

Embodiments of the disclosure provide an air cleaner including a filter module with a reduced volume that is achieved by separating a filter member and a frame for supporting the filter member.

Embodiments of the disclosure provide an air cleaner including a filter module with improved assemblability.

An air cleaner according to an example embodiment includes: a housing including an inlet and an outlet; a blower fan; and a filter module including a first plate, a second plate arranged to face the first plate, a first coupling portion formed on at least one of the first plate or the second plate, and a filter arranged between the first plate and the second plate and including a second coupling portion, wherein the filter includes: a first filter portion configured to filter the air introduced from the inlet, and separably coupled to the first plate and the second plate, and a second filter portion configured to filter the air passed through the first filter portion, and separably coupled to the first plate and the second plate, wherein the first coupling portion and the second coupling portion are separably coupled to each other.

An air cleaner according to an example embodiment includes: a housing including an inlet and an outlet; a blower fan; a filter module including a first plate, a second plate arranged to face the first plate, and a filter arranged between the first plate and the second plate; and a filter coupling opening formed such that the filter module is configured to be coupled to or separated from the inside of the housing, wherein the filter includes a first filter portion configured to filter air passed through the inlet and formed as a single body, and a second filter portion configured to filter air passed through the first filter portion, wherein the second filter portion is separably hooked to at least one of the first plate or the second plate.

A filter module according to an example embodiment includes: a first plate, a second plate arranged to face the first plate, a first coupling portion formed on at least one of the first plate or the second plate, and a filter arranged between the first plate and the second plate and including a second coupling portion, wherein the first coupling portion further includes a plurality of hook receiving portions configured to engage with a portion of the filter, and the second coupling portion includes a plurality of locking hooks configured to engage with the hook receiving portions, and based on the first coupling portion and the second coupling portion being separated, at least one of the plurality of locking hooks or the plurality of hook receiving portions is configured to be deformed to facilitate separation of the at least one of the first plate or the second plate from the filter.

According to various example embodiments of the present disclosure, an air cleaner including a filter module with improved assemblability, allowing easy separation of a first plate, a second plate, and a filter portion can be provided.

According to various example embodiments of the present disclosure, an air cleaner including a filter module in which a connection between components is easily separated through a hook-coupling structure can be provided.

The effects of the present disclosure are not limited to the effects described above, and other effects that are not described will be clearly understood by those skilled in the art from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view of an air cleaner according to various embodiments;

FIG. 2 is a cross-sectional view of an air cleaner according to various embodiments;

FIG. 3 is an exploded perspective view of an air cleaner according to various embodiments;

FIG. 4 is a perspective view of a filter module of an air cleaner according to various embodiments;

FIG. 5 is an exploded perspective view of a filter module of an air cleaner according to various embodiments;

FIG. 6 is a cross-sectional view of a filter module of an air cleaner according to various embodiments;

FIG. 7 is a partial cross-sectional view of a filter module of an air cleaner according to various embodiments;

FIG. 8 is a partial perspective view of a filter module of an air cleaner according to various embodiments;

FIG. 9 is a partial exploded perspective view of a filter module of an air cleaner according to various embodiments;

FIG. 10 is a perspective view of an air cleaner according to various embodiments;

FIG. 11 is a cross-sectional view of an air cleaner according to various embodiments.

### DETAILED DESCRIPTION

Various example embodiments described in the disclosure and the configurations shown in the drawings are simply examples of the disclosure, and various modifications may be made at the time of filing of the disclosure.

In the description of the drawings, like numbers refer to like elements throughout the description of the drawings.

The terms used herein are for the purpose of describing the various embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the disclosure, and do not exclude the presence or addition of one or more other features, numbers, steps, operations, elements, parts, or combinations thereof.

In this disclosure, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

It will be understood that, although the terms first, second, etc. used in the disclosure may be used herein to describe various components, these components should not be limited by these terms. These terms are simply used to distinguish one component from another. For example, a first element could be termed a second element, and similarly, a second element could be termed a first element without departing from the scope of the disclosure. The term “and/or” includes combinations of one or all of a plurality of associated listed items.

In addition, the meaning of “identical” or “same” in the disclosure may include having similar properties or similarity within a certain range. In addition, “identical” or “same” refers to “substantially identical”. It should be understood that the meaning of “substantially identical” refers to a value that falls within an error range in manufacturing or a value having a difference within a range that does not have significance with respect to a reference value.

The terms, such as “˜part”, “˜device”, “˜block”, “˜member”, “˜module”, and the like may refer to a unit for processing at least one function or act. For example, the terms may refer to at least one process processed by at least one hardware, such as a field-programmable gate array (FPGA) and/or application specific integrated circuit (ASIC), software stored in memories, or processors.

In the following description, the terms “front,” “rear,” “left,” and “right,” are defined based on the directions illustrated in the drawings, but the terms need not restrict the shape and position of the respective components.

Although an air cleaner is illustrated as an example below, the present disclosure is not limited to an air cleaner and may be applied to other air conditioners in which air flows inside. For example, the present disclosure may be applied to a heating/cooling device, which is a type of air conditioner, other than an air cleaner.

Various embodiments and the terms used therein are not intended to limit the technology disclosed herein to specific forms, and the disclosure should be understood to include various modifications, equivalents, and/or alternatives to the corresponding embodiments.

A singular expression may include a plural expression unless otherwise indicated herein or clearly contradicted by context.

When an element (e.g., a first element) is referred to as being “(functionally or communicatively) coupled,” or “connected” to another element (e.g., a second element), the first element may be connected to the second element, directly (e.g., wired, wirelessly), or through a third element.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

An air conditioner according to various embodiments is a device that performs functions such as purification, ventilation, humidity control, cooling or heating in an air conditioning space (hereinafter referred to as “indoor space”), and particularly a device having at least one of these functions.

According to an embodiment, an air conditioner may include a heat pump device to perform a cooling function or a heating function. The heat pump device may include a refrigeration cycle in which a refrigerant is circulated through a compressor, a first heat exchanger, and an expansion device and a second heat exchanger. All components of the heat pump device may be embedded in one housing forming an exterior of an air conditioner, which includes a window-type air conditioner or a portable air conditioner. On the other hand, some components of the heat pump device may be divided and embedded in a plurality of housings forming a single air conditioner, which includes a wall-mounted air conditioner, a stand-type air conditioner, and a system air conditioner.

The air conditioner including the plurality of housings may include at least one outdoor unit installed outdoors and at least one indoor unit installed indoors. For example, the air conditioner may be provided in such a way that a single outdoor unit and a single indoor unit are connected through a refrigerant pipe. The air conditioner may be provided in such a way that a single outdoor unit is connected to two or more indoor units through a refrigerant pipe. The air conditioner may be provided in such a way that two or more outdoor units and two or more indoor units are connected through a plurality of refrigerant pipes.

The outdoor unit may be electrically connected to the indoor unit. For example, information (or commands) for controlling the air conditioner may be received through an input interface provided in the outdoor unit or the indoor unit. The outdoor unit and the indoor unit may operate simultaneously or sequentially in response to a user input.

The air conditioner may include an outdoor heat exchanger provided in the outdoor unit, an indoor heat exchanger provided in the indoor unit, and a refrigerant pipe connecting the outdoor heat exchanger and the indoor heat exchanger.

The outdoor heat exchanger may be configured to exchange heat between a refrigerant and outdoor air through a phase change of the refrigerant (e.g., evaporation or condensation). For example, while the refrigerant is condensed in the outdoor heat exchanger, the refrigerant may radiate heat to the outdoor air. While the refrigerant flowing in the outdoor heat exchanger evaporates, the refrigerant may absorb heat from the outdoor air.

The indoor unit is installed indoors. For example, according to the arrangement method of the indoor unit, the air conditioner may be classified into a ceiling-type indoor unit, a stand-type indoor unit, a wall-mounted indoor unit, and the like. For example, the ceiling-type indoor unit may be classified into a 4-way type indoor unit, a 1-way type indoor unit, a duct type indoor unit and the like according to a method of discharging air.

As mentioned above, the indoor heat exchanger may be configured to exchange heat between a refrigerant and outdoor air through a phase change of the refrigerant (e.g., evaporation or condensation). For example, while the refrigerant evaporates in the indoor unit, the refrigerant may absorb heat from the indoor air. The indoor space may be cooled by blowing the indoor air cooled through the cooled indoor heat exchanger. While the refrigerant is condensed in the indoor heat exchanger, the refrigerant may radiate heat to the indoor air. The indoor space may be heated by blowing the indoor air heated through the high-temperature indoor heat exchanger.

In other words, the air conditioner may perform a cooling or heating function through a phase change process of a refrigerant circulating between the outdoor heat exchanger and the indoor heat exchanger. To circulate the refrigerant, the air conditioner may include a compressor for compressing the refrigerant. The compressor may intake refrigerant gas through an inlet and compress the refrigerant gas. The compressor may discharge high-temperature and high-pressure refrigerant gas through an outlet. The compressor may be disposed inside the outdoor unit.

Through the refrigerant pipe, the refrigerant may be sequentially circulated through the compressor, the outdoor heat exchanger, the expansion device, and the indoor heat exchanger or sequentially circulated through the compressor, the indoor heat exchanger, the expansion device, and the outdoor heat exchanger.

For example, in the air conditioner, when a single outdoor unit and a single indoor unit are directly connected through a refrigerant pipe, the refrigerant may be circulated between the single outdoor unit and the single indoor unit through the refrigerant pipe.

For example, in the air conditioner, when a single outdoor unit is connected to two or more indoor units through a refrigerant pipe, the refrigerant may flow from the single outdoor unit to the plurality of indoor units through branched refrigerant pipes. Refrigerants discharged from the plurality of indoor units may be combined and circulated to the outdoor unit. For example, through a separate refrigerant pipe, each of the plurality of indoor units may be directly connected in parallel to the single outdoor unit.

Each of the plurality of indoor units may be operated independently according to an operation mode set by a user. In other words, some of the plurality of indoor units may be operated in a cooling mode while others of the plurality of indoor units is operated in a heating mode. The refrigerant may be selectively introduced into each indoor unit in a high-pressure state or a low-pressure state, discharged, and circulated to the outdoor unit along a circulation path that is designated through a flow path switching valve to be described later.

For example, in the air conditioner, when two or more outdoor units and two or more indoor units are connected through the plurality of refrigerant pipes, refrigerants discharged from the plurality of outdoor units may be combined and flow through one refrigerant pipe, and then diverged again at a certain point and introduced into the plurality of indoor units.

All of the plurality of outdoor units may be driven or at least some of the plurality of outdoor units may not be driven according to a driving load according to an operation amount of the plurality of indoor units. A flow path switching valve, the refrigerant may be provided to be introduced into and circulated to an outdoor unit that is selectively driven. The air conditioner may include the expansion device to lower the pressure of the refrigerant flowing into the heat exchanger. For example, the expansion device may be disposed inside the indoor unit or inside the outdoor unit, or disposed inside the indoor unit and the outdoor unit.

For example, the expansion device may lower a temperature and pressure of the refrigerant using a throttling effect. The expansion device may include an orifice configured to reduce a cross-sectional area of a flow path. A temperature and pressure of the refrigerant passing through the orifice may be lowered.

For example, the expansion device may be implemented as an electronic expansion valve configured to adjust an opening ratio (a ratio of a cross-sectional area of a flow path of a valve in a partially opened state to a cross-sectional area of the flow path of the valve in a fully open state. According to the opening ratio of the electronic expansion valve, the amount of refrigerant passing through the expansion device may be adjusted.

The air conditioner may further include a flow path switching valve disposed on the refrigerant circulation path. The flow path switching valve may include a 4-way valve. The flow path switching valve may determine a refrigerant circulation path depending on an operation mode of the indoor unit (e.g., cooling operation or heating operation). The flow path switching valve may be connected to the outlet of the compressor.

The air conditioner may include an accumulator. The accumulator may be connected to the inlet of the compressor. A low-temperature and low-pressure refrigerant, which is evaporated in the indoor heat exchanger or the outdoor heat exchanger, may flow into the accumulator.

When a refrigerant mixture of refrigerant liquid and refrigerant gas is introduced, the accumulator may separate the refrigerant liquid from the refrigerant gas, and supply the refrigerant gas, from which the refrigerant liquid is separated, to the compressor.

An outdoor fan may be provided near the outdoor heat exchanger. The outdoor fan may blow outdoor air to the outdoor heat exchanger to promote heat exchange between the refrigerant and the outdoor air.

The outdoor unit of the air conditioner may include at least one sensor. For example, the sensor of the outdoor unit may be provided as an environment sensor. The outdoor unit sensor may be disposed at a certain position of the inside or the outside of the outdoor unit. For example, the outdoor unit sensor may include a temperature sensor configured to detect an air temperature around the outdoor unit, a humidity sensor configured to detect air humidity around the outdoor unit, or a refrigerant temperature sensor configured to detect a refrigerant temperature in a refrigerant pipe passing through the outdoor unit, or a refrigerant pressure sensor configured to detect a refrigerant pressure in a refrigerant pipe passing through the outdoor unit.

The outdoor unit of the air conditioner may include an outdoor unit communication circuitry. The outdoor unit communication circuitry may be configured to receive a control signal from an indoor unit controller of the air conditioner, which will be described later. Based on a control signal received through the outdoor unit communication circuitry, the outdoor unit may control the operation of the compressor, the outdoor heat exchanger, the expansion device, the flow path switching valve, the accumulator, or the outdoor fan. The outdoor unit may transmit a sensing value detected by the outdoor unit sensor to the indoor unit controller through the outdoor unit communication circuitry.

The indoor unit of the air conditioner may include a housing, a blower configured to circulate air inside or outside the housing, and the indoor heat exchanger configured to exchange heat with air introduced into the housing.

The housing may include an inlet. Indoor air may flow into the housing through the inlet.

The indoor unit of the air conditioner may include a filter provided to filter out foreign substance in air that is introduced into the inside of the housing through the inlet.

The housing may include an outlet. Air flowing inside the housing may be discharged to the outside of the housing through the outlet.

An airflow guide configured to guide a direction of air discharged through the outlet may be provided in the housing of the indoor unit. For example, the airflow guide may include a blade positioned in the outlet. For example, the airflow guide may include an auxiliary fan for regulating an exhaust airflow, but is not limited thereto. Alternatively, the airflow guide may be omitted.

The indoor heat exchanger and the blower arranged on a flow path connecting the inlet and the outlet may be disposed inside the housing of the indoor unit.

The blower may include an indoor fan and a fan motor. For example, the indoor fan may include an axial fan, a mixed flow fan, a crossflow fan and a centrifugal fan.

The indoor heat exchanger may be arranged between the blower and the outlet or between the inlet and the blower. The indoor heat exchanger may absorb heat from air introduced through the inlet or transfer heat to air introduced through the inlet. The indoor heat exchanger may include a heat exchange tube through which a refrigerant flows, and a heat exchanger fin in contact with the heat exchange tube to increase a heat transfer area.

The indoor unit of the air conditioner may include a drain tray disposed below the indoor heat exchanger to collect condensed water generated in the indoor heat exchanger. The condensed water contained in the drain tray may be drained to the outside through a drain hose. The drain tray may be provided to support the indoor heat exchanger.

The indoor unit of the air conditioner may include an input interface. The input interface may include various circuitry and any type of user input means including a button, a switch, a touch screen and/or a touch pad. A user can directly input setting data (e.g., desired indoor temperature, cooling/heating/dehumidifying/air cleaning operation mode setting, outlet selection setting, and/or air volume setting) through the input interface.

The input interface may be connected to an external input device. For example, the input interface may be electrically connected to a wired remote controller. The wired remote controller may be installed at a specific location (e.g., a part of a wall) in an indoor space. A user can input setting data related to the operation of the air conditioner by manipulating the wired remote controller. An electrical signal corresponding to the setting data obtained through the wired remote controller may be transmitted to the input interface. Further, the input interface may include an infrared sensor. A user can remotely input the setting data for the operation of the air conditioner using a wireless remote controller. The setting data received through the wireless remote controller may be transmitted to the input interface as an infrared signal.

Further, the input interface may include a microphone. A user's voice command may be obtained through the microphone. The microphone may convert a user's voice command into an electrical signal and transmit the electrical signal to the indoor unit controller. The indoor unit controller may control components of the air conditioner to execute a function corresponding to the user's voice command. The setting data obtained through the input interface (e.g., desired indoor temperature, cooling/heating/dehumidifying/air cleaning operation mode setting, outlet selection setting, and/or air volume setting) may be transmitted to the indoor unit controller to be described later. For example, the setting data obtained through the input interface may be transmitted to the outside, that is, to the outdoor unit or a server through an indoor unit communication circuitry to be described later.

The indoor unit of the air conditioner may include a power module. The power module may be connected to an external power source to supply power to components of the indoor unit.

The indoor unit of the air conditioner may include an indoor unit sensor. The indoor unit sensor may be an environment sensor disposed inside or outside the housing. For example, the indoor unit sensor may include one or more temperature sensors and/or humidity sensors disposed in a predetermined space inside or outside the housing of the indoor unit. For example, the indoor unit sensor may include a refrigerant temperature sensor configured to detect a refrigerant temperature of a refrigerant pipe passing through the indoor unit. For example, the indoor unit sensor may include a refrigerant temperature sensor configured to detect a temperature of an entrance, a middle portion and/or an exit of the refrigerant pipe passing through the indoor heat exchanger.

For example, each environmental information detected by the indoor unit sensor may be transmitted to the indoor unit controller to be described later or transmitted to the outside through the indoor unit communication circuitry to be described later.

The indoor unit of the air conditioner may include the indoor unit communication circuitry. The indoor unit communication circuitry may include at least one of a short-range wireless communication module and a long-range wireless communication module. The indoor unit communication circuitry may include at least one antenna for wirelessly communicating with other devices. The outdoor unit may include the outdoor unit communication circuitry. The outdoor unit communication circuitry may also include at least one of a short-range wireless communication module and a long-range wireless communication module.

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server on a mobile communication network.

The indoor unit communication circuitry may communicate with an external device such as a server, a mobile device and other home appliances through an access point (AP). The access point (AP) may connect a local area network (LAN), to which an air conditioner or a user device is connected, to a wide area network (WAN) to which a server is connected. The air conditioner or the user device may be connected to the server through the wide area network (WAN). The indoor unit of the air conditioner may include the indoor unit controller configured to control components of the indoor unit including the blower. The outdoor unit of the air conditioner may include an outdoor unit controller configured to control components of the outdoor unit including the compressor. The indoor unit controller may communicate with the outdoor unit controller through the indoor unit communication circuitry and the outdoor unit communication circuitry. The outdoor unit communication circuitry may transmit a control signal generated by the outdoor unit controller to the indoor unit communication circuitry, or transmit a control signal, which is transmitted from the indoor unit communication circuitry, to the outdoor unit controller. In other words, the outdoor unit and the indoor unit may perform bi-directional communication. The outdoor unit and the indoor unit may transmit and receive various signals generated during operation of the air conditioner.

The outdoor unit controller may be electrically connected to components of the outdoor unit and may control operations of each component. For example, the outdoor unit controller may adjust a frequency of the compressor and control the flow path switching valve to change a circulation direction of the refrigerant. The outdoor unit controller may adjust a rotational speed of the outdoor fan. Further, the outdoor unit controller may generate a control signal for adjusting the opening degree of the expansion valve. Under the control of the outdoor unit controller, the refrigerant may be circulated along the refrigerant circulation circuit including the compressor, the flow path switching valve, the outdoor heat exchanger, the expansion valve, and the indoor heat exchanger.

Various temperature sensors included in the outdoor unit and the indoor unit may transmit electrical signals corresponding to detected temperatures to the outdoor unit controller and/or the indoor unit controller. For example, the humidity sensors included in the outdoor unit and the indoor unit may respectively transmit electrical signals corresponding to the detected humidity to the outdoor unit controller and/or the indoor unit controller.

The indoor unit controller may obtain a user input from a user device including a mobile device through the indoor unit communication circuitry, or directly obtain a user input through the input interface or the remote controller. The indoor unit controller may control components of the indoor unit including the blower in response to the received user input. The indoor unit controller may transmit information related to the received user input to the outdoor unit controller of the outdoor unit.

The outdoor unit controller may control components of the outdoor unit including the compressor based on the information related to the user input received from the indoor unit. For example, when a control signal corresponding to a user input for selecting an operation mode such as a cooling operation, a heating operation, a fan operation, a defrosting operation, or a dehumidifying operation is received from the indoor unit, the outdoor unit controller may control components of the outdoor unit to perform an operation of the air conditioner corresponding to the selected operation mode.

The outdoor unit controller and indoor unit controller may include a processor and a memory, respectively. The indoor unit controller may include at least one first processor and at least one first memory, and the outdoor unit controller may include at least one second processor and at least one second memory.

The memory may memorize/store various types of information necessary for the operation of the air conditioner. The memory may store instructions, applications, data and/or programs necessary for the operation of the air conditioner. For example, the memory may store various programs for the cooling operation, the heating operation, the dehumidifying operation, and/or the defrosting operation of the air conditioner. The memory may include volatile memory such as a static random access memory (S-RAM) and a dynamic random access memory (D-RAM) for temporarily storing data. In addition, the memory may include a non-volatile memory such as a read only memory (ROM), an erasable programmable read only memory (EPROM), and an electrically erasable programmable read only memory (EEPROM) for long-term storage of data.

The processor may include various processing circuitry and generate a control signal for controlling an operation of the air conditioner based on instructions, applications, data, and/or programs stored in the memory. The processor may be hardware and may include a logic circuit and an arithmetic circuit. The processor may process data according to a program and/or instructions provided from the memory, and may generate a control signal according to a processing result. The memory and the processor may be implemented as one control circuit or as a plurality of circuits.

The indoor unit of the air conditioner may include an output interface. The output interface may include various circuitry and be electrically connected to the indoor unit controller, and output information related to the operation of the air conditioner under the control of the indoor unit controller. For example, the output interface may output information such as an operation mode selected by a user input, a wind direction, a wind volume, and a temperature. Further, the output interface may output sensing information obtained from the indoor unit sensor or the outdoor unit sensor, and output warning/error messages.

The output interfaces may include a display and a speaker. The speaker may be a sound device and configured to output various sounds. The display may display information, which is input by a user or provided to a user, as various graphic elements. For example, operation information of the air conditioner may be displayed as at least one of an image and text. Further, the display may include an indicator providing specific information. The display may include a liquid crystal display (LCD) panel, a light emitting diode (LED) panel, an organic light emitting diode (OLED) panel, a micro-LED panel, and/or a plurality of LEDs.

Hereinafter, an air conditioner according to various embodiments will be described in greater detail with reference to the drawings. For convenience of description, an air cleaner 1 is described as an example of an air conditioner, but the present disclosure is not limited to the air cleaner 1 and may be applied to various home appliances including an indoor unit of an air conditioner including a heat exchanger.

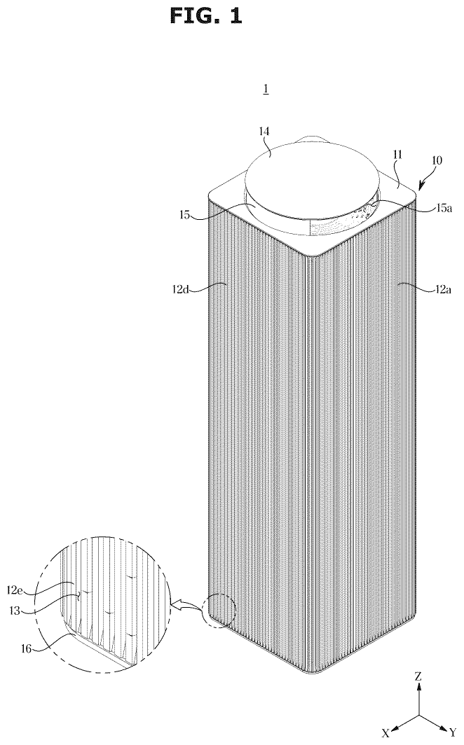

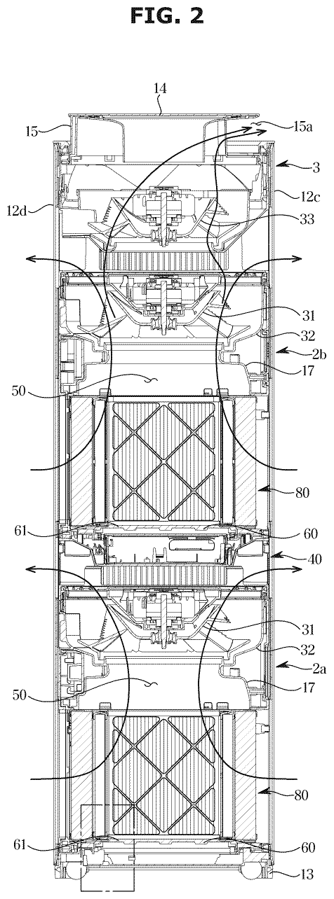

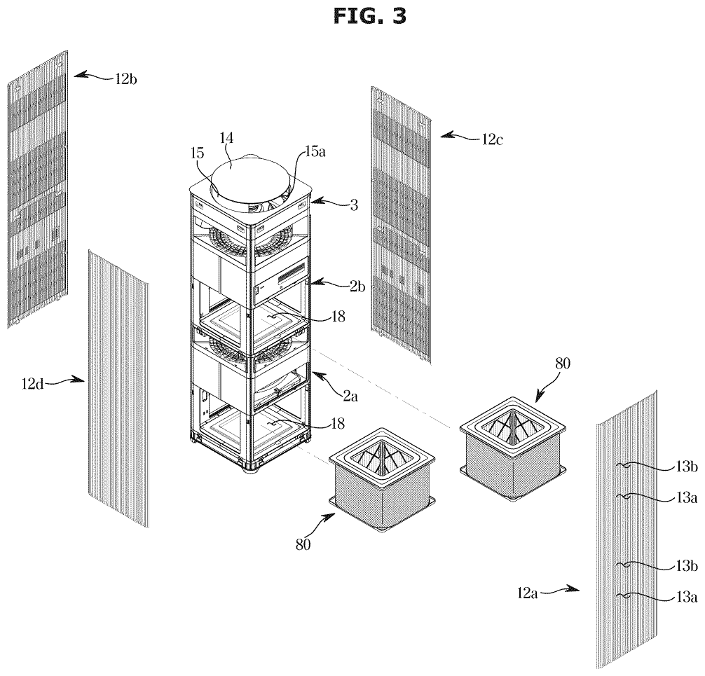

FIG. 1 is a perspective view of an air cleaner 1 according to various embodiments, FIG. 2 is a cross-sectional view of an air cleaner 1 according to various embodiments, and FIG. 3 is an exploded perspective view of an air cleaner 1 according to various embodiments.

Referring to FIGS. 1 and 2, the air cleaner 1 may include a housing 10. The housing 10 may form an external appearance of the air cleaner 1.

The housing 10 may include a frame body and vent panels 12a, 12b, 12c, and 12d provided on the outside of the frame body. The frame body may support various components of the air cleaner 1. The frame body may be arranged to accommodate various components of the air cleaner 1. The frame body may be arranged to be at least partially covered by the vent panels 12a, 12b, 12c, and 12d.

The vent panels 12a, 12b, 12c, and 12d may be separably mounted on the frame body. For example, the vent panels 12a, 12b, 12c, and 12d may include a first vent panel 12a forming the front of the air cleaner 1, a second vent panel 12b forming the rear of the air cleaner 1, a third vent panel 12c forming the right side of the air cleaner 1, and a fourth vent panel 12d forming the left side of the air cleaner 1. The first vent panel 12a may be referred to as a front panel. The second vent panel 12b may be referred to as a rear panel. The third vent panel 12c may be referred to as a right panel. The fourth vent panel 12d may be referred to as a left panel.

The first vent panel 12a, the second vent panel 12b, the third vent panel 12c, and the fourth vent panel 12d may be provided as separate components. However, at least some vent panels among the first vent panel 12a, the second vent panel 12b, the third vent panel 12c, and the fourth vent panel 12d may be formed as a single body. At least some vent panels among the first vent panel 12a, the second vent panel 12b, the third vent panel 12c, and the fourth vent panel 12d may be separable from the frame body.

The vent panels 12a, 12b, 12c, and 12d may include a panel portion 12e. The panel portion 12e may include a plurality of ribs. The plurality of ribs may extend in one direction. For example, the plurality of ribs may extend in an up-down direction. However, the present disclosure is not limited thereto.

The panel portion 12e may be formed over the entire area of the vent panels 12a, 12b, 12c, and 12d. For example, the panel portion 12e may be provided with a uniform pattern over the entire area of the vent panels 12a, 12b, 12c, and 12d. This enhances the freedom of design of the vent panels 12a, 12b, 12c, and 12d and improves aesthetics.

The housing 10 may include a vent 13. For example, the vent 13 may be formed in the vent panels 12a, 12b, 12c, and 12d. The vent 13 may extend in the up-down direction. The vent 13 may be formed in plural. For example, the plurality of vents 13 may be arranged in a direction perpendicular to the up-down direction (Z direction). For example, the plurality of vents 13 may be arranged along the left-right direction (Y direction) or along the front-back direction (X direction).

The vent 13 may be formed corresponding to the panel portion 12e. For example, the vent 13 may be an opening formed between the plurality of ribs of the panel portion 12e. Air outside the housing 10 may be introduced into the housing 10 through the vent 13 or air may be discharged from the housing 10 through the vent. The vent 13 may include a plurality of openings.

The housing 10 may include an inlet 13a and an outlet 13b. The inlet 13a may be provided such that air outside the housing 10 may be introduced into the housing 10. The outlet 13b may be provided such that air inside the housing 10 may be discharged to the outside of the housing 10. The inlet 13a and the outlet 13b may be formed in the vent panels 12a, 12b, 12c, and 12d. The vent 13 may include the inlet 13a and the outlet 13b. The inlet 13a may be provided as a part of the vent 13, and the outlet 13b may be provided as another part of the vent 13. A part of the vent 13 may form the inlet 13a, and another part of the vent 13 may form the outlet 13b.

The housing 10 may include an inlet opening and an outlet opening. The inlet opening and the outlet opening may be formed in the housing 10. The inlet opening may be provided to correspond to the inlet 13a of the vent 13. The outlet opening may be provided to correspond to the outlet 13b of the vent 13.

The inlet 13a and the outlet 13b may be formed in each of the first vent panel 12a, the second vent panel 12b, the third vent panel 12c, and the fourth vent panel 12d.

For example, air outside the housing 10 may flow into the housing 10 from all sides of the housing 10 through the inlet 13a. For example, air outside the housing 10 may flow into the housing 10 from all directions through the inlet 13a.

In addition, for example, air inside the housing 10 may flow outward from the housing 10 to all sides of the housing 10 through the outlet 13b. For example, air inside the housing 10 may flow from the housing 10 to the outside of the housing 10 in all directions through the outlet 13b.

Since air is introduced and/or discharged in all directions, air circulation inside the housing 10 may be smoothly achieved. The air cleaner 1 may achieve high dust collection efficiency.

The housing 10 may include an upper panel 11. The upper panel 11 may be provided at the upper end of the housing 10. The upper panel 11 may be arranged on the upper side of the housing 10.

The upper panel 11 may be provided with a user interface. For example, the user interface may include a manipulation portion. The user interface may receive input from a user or output operation information of the air cleaner 1 to the user.

The housing 10 may include a support 16. The support 16 may be arranged at the lower end of the housing 10 to support elements of the housing 10 and the air cleaner 1.

The air cleaner 1 may include a plurality of cleaning modules 2a and 2b. The plurality of cleaning modules 2a and 2b may be arranged approximately along a vertical direction. For example, the air cleaner 1 may include a first cleaning module 2a and a second cleaning module 2b arranged on the first cleaning module 2a. The air cleaner 1 may include a vent module 3 located on the plurality of cleaning modules 2a and 2b and configured to additionally discharge purified air. Although two cleaning modules 2 are illustrated in the drawings, the number of cleaning modules 2 may be one or three or more. In addition, the air cleaner 1 may include a plurality of cleaning modules 2a and 2b according to various embodiments.

The plurality of cleaning modules 2a and 2b may be separated by a separating portion 40. For example, the separating portion 40 may be arranged between the first cleaning module 2a and the second cleaning module 2b. The plurality of cleaning modules 2a and 2b may include the same configuration. Accordingly, material costs may be reduced. However, the arrangement of the plurality of cleaning modules 2a and 2b is not limited thereto, and not all of the cleaning modules 2 may include the same configuration.

Hereinafter, for convenience of description, the configuration of the cleaning module 2 will be described based on a single cleaning module 2.

The cleaning module 2 may include a blower fan 31. The blower fan 31 may generate a blowing force. The blower fan 31 may move air. The blower fan 31 may force air to flow. The blower fan 31 may generate the flow of air inside the housing 10 by rotation. The blower fan 31 may allow air to be drawn in through the inlet 13a and be discharged through the outlet 13b. For example, the blower fan 31 may move air upward. However, the present disclosure is not limited thereto, and when the inlet 13a is provided above the outlet 13b, the blower fan 31 may move air downward.

The blower fan 31 may be arranged inside the housing 10. The blower fan 31 may be arranged downstream of the inlet 13a. The blower fan 31 may be arranged upstream of the outlet 13b. The blower fan 31 may be arranged between the inlet 13a and the outlet 13b. However, there is no limitation on the arrangement of the blower fan 31 and the number of the blower fans 31 included in the cleaning module 2.

A guide path 50 may be formed inside the housing 10. The guide path 50 may extend from the inlet 13a to the outlet 13b. Air blown by the blower fan 31 may flow into the guide path 50.

The air may pass through the housing 10 along an airflow direction. The airflow direction may be a direction from the upstream to the downstream of the guide path 50 formed inside the housing 10. For example, the airflow direction inside the housing 10 may include a vertical direction. The airflow direction may be a direction in which air that has flowed into the housing 10 through the inlet 13a is directed toward the outlet 13b. For example, the airflow direction may be a direction in which air flows into the housing 10 through the inlet 13a and then passes through the filter module 80 and the blower fan 31. For example, air introduced from all sides of the housing 10 by the blower fan 31 may flow upward and then be discharged again to all sides of the housing 10. However, the airflow direction is not limited to the above example.

The air cleaner 1 may include an air guide 17. Air introduced into the housing 10 through the inlet 13a may be guided toward the blower fan 31 through the air guide 17. The air guide 17 may form a part of the guide path 50 inside thereof. The air guide 17 may guide air inside the housing 10 and/or air of the guide path 50 to the blower fan 31. Air passing through the inside of the air guide 17 may flow to the inside of a fan housing 32 and the blower fan 31.

The air cleaner 1 may include the fan housing 32. The blower fan 31 may be arranged inside the fan housing 32. The fan housing 32 may form a part of the guide path 50 inside thereof. The fan housing 32 may guide the flow of air inside the housing 10. The fan housing 32 may be connected to the air guide 17.

The cleaning module 2 may include a filter module 80. The filter module 80 may be provided to filter air. The filter module 80 may be arranged inside the housing 10. The filter module 80 may be coupled to or separated from the housing 10 through a filter coupling opening 18 formed in the frame body. The filter module 80 may be arranged to allow air to pass therethrough before being discharged through the outlet 13b. For example, the filter module 80 may be arranged between the inlet 13a and the outlet 13b. The filter module 80 may filter air that is introduced into the housing 10 through the inlet 13a by the blower fan 31. The filtered air may be discharged to the outside of the housing 10 through the outlet 13b.

For example, the filter module 80 may be arranged below the blower fan 31. For example, the blower fan 31 may be arranged above the filter module 80. However, the arrangement of the filter module 80 and the blower fan 31 is not limited to the example described above.

The filter module 80 may be positioned on the guide path 50. The blower fan 31 may be positioned on the guide path 50. For example, air that has entered the inside of the guide path 50 through the inlet 13a may flow to the outlet 13b after passing through the filter module 80. The air that has flowed to the outlet 13b may exit from the guide path 50.

The air cleaner 1 may include the vent module 3 arranged on the upper side of the cleaning module 2. The air inside the housing 10 may be discharged to the outside of the housing 10 through the vent module 3 in various methods. For example, the vent module 3 may include a discharge port 15a of which some components are moved above the upper panel 11 when discharging air, to discharge air therethrough.

The vent module 3 may include a discharge cover 14 and a cover support portion 15 provided on the edge of the discharge cover 14. The discharge cover 14 may form the discharge port 15a together with the cover support portion 15. The discharge cover 14 may be provided to be movable and rotatable with respect to the housing 10. For example, the discharge cover 14 and the cover support portion 15 may have a cylindrical shape with an open bottom.

The vent module 3 may include a discharge fan 33. The discharge fan 33 may discharge a portion of the air blown by the blower fan 31 through the discharge port 15a while the discharge cover 14 opens the discharge port 15a. During operation of the discharge fan 33 s, the air cleaner 1 may discharge the air from the discharge port 15a further away from the air cleaner 1. For example, while the discharge fan 33 is operating, the air cleaner 1 may discharge air from the discharge port 15a more rapidly.

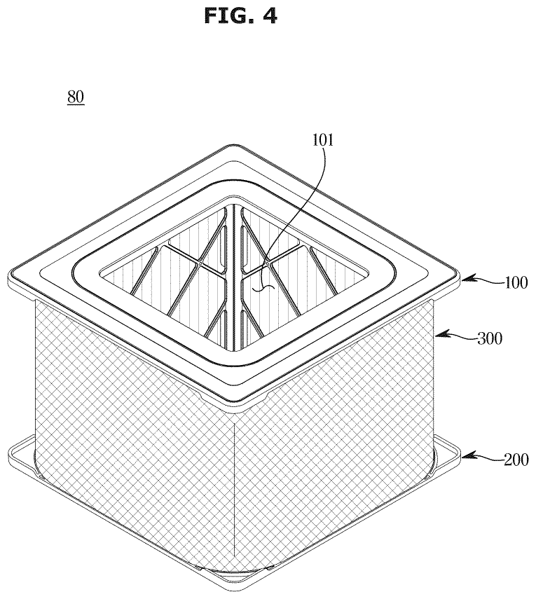

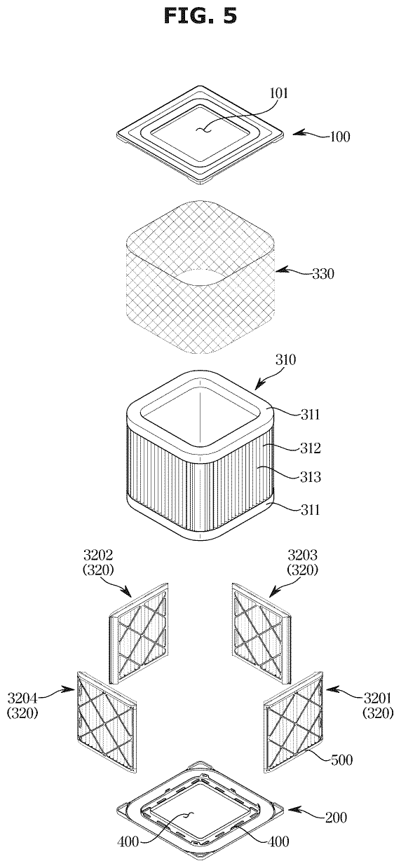

FIG. 4 is a perspective view of a filter module 80 of an air cleaner 1 according to various embodiments, and FIG. 5 is an exploded perspective view of a filter module 80 of an air cleaner 1 according to various embodiments.

Referring to FIGS. 4 and 5, the filter module 80 may include a first plate 100, a second plate 200 arranged to face the first plate 100, and a filter portion (also referred to as a filter) 300.

The first plate 100 may form the upper portion of the external appearance of the filter module 80. The first plate 100 may be formed in an approximately rectangular plate shape. The first plate 100 may include a first plate opening 101 for passing air that has passed through the filter portion 300. For example, air that has passed through the inlet 13a and entered the housing 10 may pass through the filter portion 300, the first plate opening 101, and the blower fan 31, and then be discharged to the outside of the housing 10 through the outlet 13b.

The second plate 200 may form the lower portion of the external appearance of the filter module 80. The second plate 200 may be formed in a substantially rectangular plate shape. The second plate 200 may include a second plate opening 201.

The second plate 200 may be formed in the same shape as the first plate 100. Since the first plate 100 and the second plate 200 are formed in the same shape, the manufacturing cost may be reduced. However, the first plate 100 and the second plate 200 may not be formed in the same shape.

The filter portion 300 may filter air introduced from the outside of the housing 10. The filter portion 300 may include a first filter portion 310, a second filter portion 320, and a third filter portion 330.

The first filter portion 310 may be provided to filter air. For example, the first filter portion 310 may be a dust collecting filter formed of copper antibacterial fiber. The first filter portion 310 may prevent and/or reduce bacteria or mold from growing inside the filter portion 300.

The first filter portion 310 may include a molding member 311 for coupling to at least one of the first plate 100 or the second plate 200. However, the shape and material of the first filter portion 310 are not limited to the above-described examples.

The second filter portion 320 may be provided to filter air. For example, the second filter portion 320 may be a deodorizing filter. The second filter portion 320 may be provided to deodorize air. The second filter portion 320 may be provided to remove odorous substances in the air. The second filter portion 320 may be provided to sterilize air. For example, the second filter portion 320 may sterilize the air by decomposing organic substances in the air. The air flowing inside the housing 10 may have its odor removed while passing through the second filter portion 320.

The second filter portion 320 may be located downstream of the first filter portion 310 in the airflow direction. The second filter portion 320 may be arranged between the first filter portion 310 and the blower fan 31. However, the present disclosure is not limited thereto, and the second filter portion 320 may also be located upstream of the first filter portion 310 in the airflow direction. However, the shape and material of the second filter portion 320 are not limited to the above-described example.

The second filter portion 320 may include a plurality of inner filters 3201, 3202, 3203, and 3204. For example, the second filter portion 320 may include a first inner filter 3201, a second inner filter 3202, a third inner filter 3203, and a fourth inner filter 3204. The first inner filter 3201 may be positioned corresponding to the first vent panel 12a, the second inner filter 3202 may be positioned corresponding to the second vent panel 12b, the third inner filter 3203 may be positioned corresponding to the third vent panel 12c, and the fourth inner filter 3204 may be positioned corresponding to the fourth vent panel 12d.

The first inner filter 3201, the second inner filter 3202, the third inner filter 3203, and the fourth inner filter 3204 may be formed in the same shape. Since the first inner filter 3201, the second inner filter 3202, the third inner filter 3203, and the fourth inner filter 3204 are formed in the same shape, the manufacturing cost may be reduced. However, the first inner filter 3201, the second inner filter 3202, the third inner filter 3203, and the fourth inner filter 3204 may not be formed in the same shape.

The first filter portion 310 and the second filter portion 320 may be arranged in a direction along the circumference of the first plate opening 101. The second filter portion 320 may be arranged between the circumference of the first plate opening 101 and the first filter portion 310.

The first filter portion 310 may include a plurality of crest portions 312 formed toward the outside of the filter module 80 and a plurality of trough portions 313 arranged between the plurality of crest portions 312 and protruding toward the direction in which air flows. The plurality of crest portions 312 and the plurality of trough portions 313 may be alternately formed. Accordingly, the first filter portion 310 may have a larger area in contact with air, thereby improving the filtering efficiency.

The first filter portion 310 may be formed as a single body. Since the first filter portion 310 is arranged along the circumference of the first plate opening 101 and formed as a single body, the first filter portion 310 may filter air introduced from all directions of the housing 10.

The filter portion 300 may include a third filter portion 330 located at the outside of the first filter portion 310. The third filter portion 330 may filter out large particles of foreign substance before the air introduced from the inlet passes through the first filter portion 310.

For example, air introduced into the housing 10 through the inlet 13a may be filtered by passing through the third filter portion 330, the first filter portion 310, and the second filter portion 320. The air passed through the filter portion 300 may pass through the blower fan 31 and then be discharged to the outside of the housing 10 through the outlet 13b.

However, the above example describes an example of the filter portion 300, and the number, arrangement, and type of filters are not limited thereto.

The first plate 100, the second plate 200, and filters included in the filter portion 300 are formed of different materials and thus need to separately be disposed of or recycled. Therefore, the first plate 100 and the filter portion 300 as well as the second plate 200 and the filter portion 300 may be separably coupled to each other.

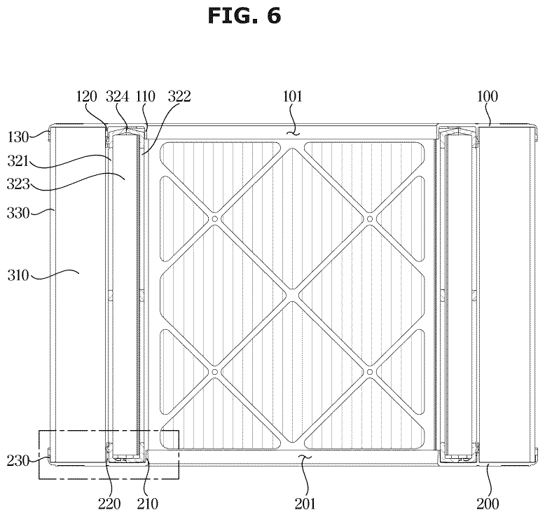

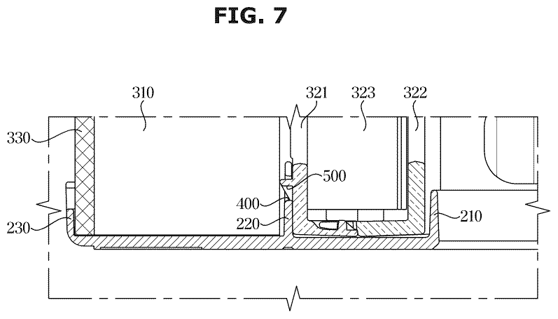

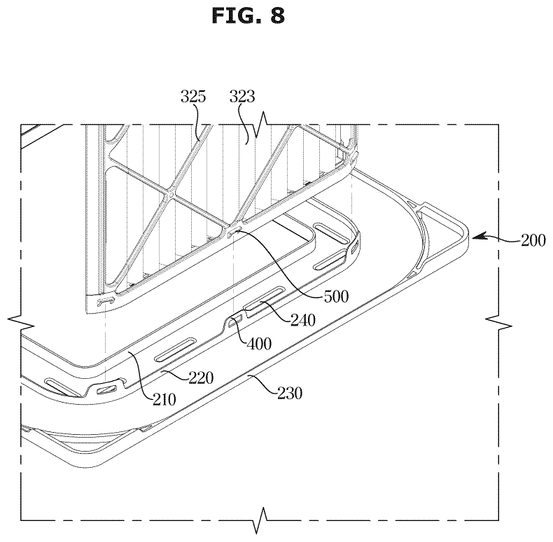

FIGS. 6 and 7 are cross-sectional views of a filter module 80 of an air cleaner 1 according to various embodiments, and FIG. 8 is a partial perspective view of a filter module 80 of an air cleaner 1 according to various embodiments.

The first plate 100 may include a first rib 110, a second rib 120, and a third rib 130 that are arranged to be spaced apart in a direction from the center of the first plate 100 toward the circumference of the first plate 100. For example, the second filter portion 320 may be arranged between the first rib 110 and the second rib 120. For example, the first filter portion 310 may be arranged between the second rib 120 and the third rib 130. For example, the third filter portion 330 may be arranged between the second rib 120 and the third rib 130.

The first rib 110, the second rib 120, and the third rib 130 may serve to fix the first filter portion 310, the second filter portion 320, and the third filter portion 330 to inhibit the first filter portion 310, the second filter portion 320, and the third filter portion 330 from moving within the filter module 80. For example, when air flows inside the housing 10, the first filter portion 310, the second filter portion 320, and the third filter portion 330 may be inhibited from being separated by the flowing air. The second plate 200 when formed in the same shape as the first plate 100 may also include a first rib 210, a second rib 220, and a third rib 230. However, the second plate 200 may not need to include all of the first rib 210, the second rib 220, and the third rib 230, and only some of the first rib 210, the second rib 220, and the third rib 230 may be formed on the second plate 200.

The second filter portion 320 may include a first filter frame 321, a second filter frame 322, and a filter member 323 accommodated between the first filter frame 321 and the second filter frame 322. The first filter frame 321 may be held by the second ribs 120 and 220, and the second filter frame 322 may be held by the first ribs 110 and 210, preventing/inhibiting the first filter frame 321 and the second filter frame 322 from being separated from an area between the first ribs 110 and 210 and the second ribs 120 and 220.

The air cleaner 1 may include a first coupling portion 400 and a second coupling portion 500 that are configured to couple at least one of the first plate 100 or the second plate 200 to the filter portion 300. For example, at least one of the first plate 100 or the second plate 200 may include the first coupling portion 400, and the filter portion 300 may include the second coupling portion 500. In the drawing, for convenience of description, the first coupling portion 400 is illustrated as being formed on the second plate 200, but the first coupling portion 400 may be formed only on the first plate 100, or may be formed only on the second plate 200, or may be formed on the first plate 100 and the second plate 200. The second coupling portion 500 may be formed on the second filter portion 320.

The first coupling portion 400 may be a hook receiving portion for accommodating a locking hook. The second coupling portion 500 may be a locking hook. In the drawing, the first coupling portion 400 is illustrated as a hook receiving portion and the second coupling portion 500 is illustrated as a locking hook, but the present disclosure is not limited thereto, and the first coupling portion 400 may be a locking hook and the second coupling portion 500 may be a hook receiving portion. In addition, the method by which the first coupling portion 400 and the second coupling portion 500 are coupled is not limited to a hook coupling structure, and may be provided in various coupling structures in which the first coupling portion 400 and the second coupling portion 500 may be separably coupled to each other.

A component of the filter module 80 formed of a filter material and a component of the filter module 80 formed of a non-filter material need to be separated from each other and disposed of. For example, the first plate 100 and the second plate 200 formed of plastic and the filter member 323 and the first filter portion 310 formed of filter material need to be separated from each other and disposed of. According to this need, the locking hook and the hook receiving portion may be separably coupled to each other. For example, when the second plate 200 and the filter portion 300 are separated from each other, the filter material included in the filter portion 300 may be easily separated by deformation of the locking hook or the hook receiving portion. The deformation of the locking hook or the hook receiving portion may refer to the locking hook or the hook receiving portion stretching or breaking to facilitate separation.

Referring to FIG. 8, the locking hook may include a plurality of locking hooks, and the hook receiving portion may include a plurality of hook receiving portions. At least one of the first plate 100 or the second plate 200 needs to be easily separated from the filter portion 300. To this end, at least one of the plurality of locking hooks or the plurality of hook receiving portions may be formed to be deformed when the first coupling portion 400 and the second coupling portion 500 are separated from each other.

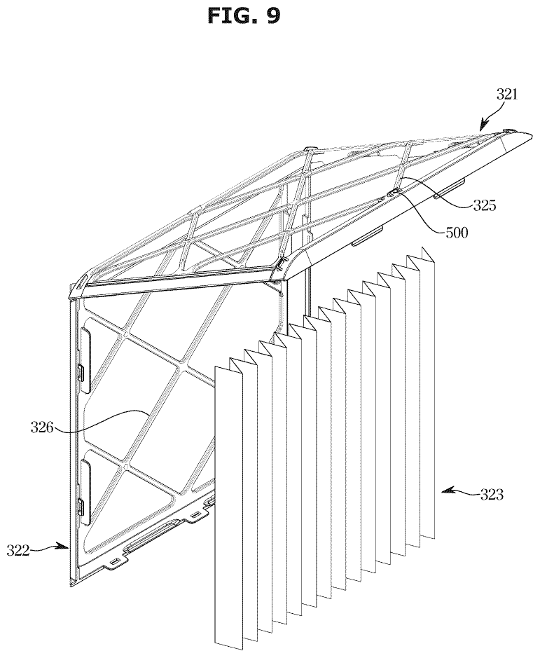

At least one of the first plate 100 or the second plate 200 may include a receiving portion for accommodating a part of the second filter portion 320. For example, the second filter portion 320 may include a hinge portion (also referred to as a hinge) 324 (see FIG. 9), and at least one of the first plate 100 or the second plate 200 may include a hinge receiving portion 240 for accommodating the hinge portion 324.

FIG. 9 is a partial exploded perspective view of a filter module 80 of an air cleaner 1 according to various embodiments. For example, FIG. 9 is a drawing illustrating an exploded view of the second filter portion 320.

The second filter portion 320 may include a first filter frame 321, a second filter frame 322, and a filter member 323 arranged between the first filter frame 321 and the second filter frame 322. The second filter portion 320 may include a hinge portion 324 connecting one end of the first filter frame 321 and one end of the second filter frame 322. The first filter frame 321 and the second filter frame 322 may rotate around the hinge portion 324 to open, allowing the filter member 323 to be accommodated therein.

The first filter frame 321 may include a first filter rib 325 forming a plurality of holes through which air may pass. The second filter frame 322 may include a second filter rib 326 forming a plurality of holes through which air may pass.

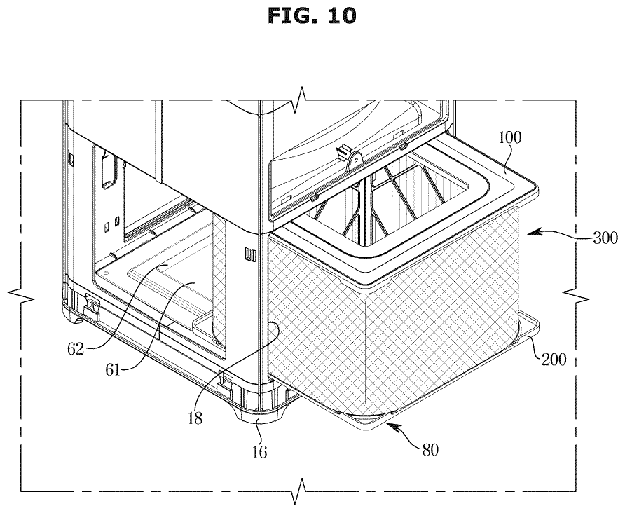

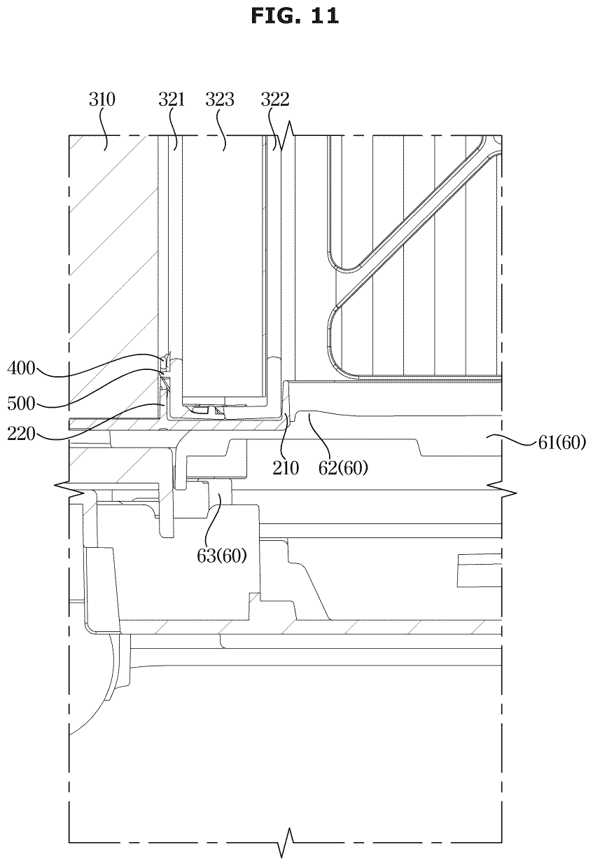

FIG. 10 is a partial perspective view of an air cleaner 1 according to various embodiments, and FIG. 11 is a cross-sectional view of an air cleaner 1 according to various embodiments.

The cleaning module 2 may include a filter support 60 arranged at the lower portion of the filter module 80 to support the filter module 80. The filter support 60 may include a support plate 61 formed in a wide plate shape, and an elastic member 63 that applies elastic force to the support plate 61 in a direction from the support plate 61 toward the filter module 80. The filter support 60 may include a filter catching portion 62 formed to catch with a part of the filter module 80. The filter catching portion 62 may prevent/inhibit the filter module 80 from being separated from the housing 10.

The filter catching portion 62 may be provided to catch with a part of the filter module 80. For example, the filter catching portion 62 may be arranged to catch with the circumference of the second plate opening 201.

The elastic member 63 may apply elastic force to the support plate 61 such that the filter module 80 is in close contact with the upper circumference of the filter coupling opening 18. For example, when the elastic member 63 applies force to the filter module 80 toward the upper part of the air cleaner 1, air mixed with foreign substances may be prevented/blocked from heading toward the blower fan 31 without passing through the filter portion 300.

An air cleaner according to an example embodiment includes: a housing including an inlet; a blower fan; and a filter module including a first plate, a second plate arranged to face the first plate, a first coupling portion formed on at least one of the first plate or the second plate, and a filter arranged between the first plate and the second plate and including a second coupling portion, wherein the filter includes: a first filter portion configured to filter air introduced from the inlet, and separably coupled to the first plate and the second plate, and a second filter portion configured to filter air passed through the first filter portion, and separably coupled to the first plate and the second plate, and the first coupling portion and the second coupling portion are separably coupled to each other.

The first plate may include a first plate opening configured to allow air passed through the filter to pass therethrough, and the first filter portion may be arranged in a direction along a circumference of the first plate opening and is formed as one body.

The second filter portion may be arranged between the first plate opening and the first filter portion.

The first coupling portion may include a hook receiving portion configured to engage with a portion of the filter, and the second coupling portion may include a locking hook configured to engage with the hook receiving portion.

The locking hook may include a plurality of locking hooks, and the hook receiving portion may include a plurality of hook receiving portions, wherein based on the first coupling portion and the second coupling portion being separated, at least one of the plurality of locking hooks or the plurality of hook receiving portions may be configured to be deformed such that the at least one of the first plate or the second plate and the filter are separable.

The second filter portion may include: a first filter frame, a second filter frame arranged to face the first filter frame, a filter member configured to be coupled to or separated from the first filter frame and the second filter frame, and a hinge configured to connect one end of the first filter frame to one end of the second filter frame.

The first plate may further include a hinge receiving portion configured to receive the hinge.

The filter may further include a molding member comprising a molded material configured to couple the first filter portion to the first plate while coupling the first filter portion to the second plate.

The filter may further include a third filter portion arranged on an outer side of the first filter portion and configured to maintain a shape of the first filter portion, the third filter portion may be configured to transmit air from the inlet toward the first filter portion.

The first coupling portion may include a locking hook configured to be coupled to the filter, and the second coupling portion may include a hook receiving portion configured to engage with the locking hook.

The housing may further include a side panel forming an external appearance, and a filter coupling opening configured to couple or separate the filter module from an inner side of the side panel as a whole.

The air cleaner may further include a filter support arranged at a lower portion of the filter module and configured to support the filter module, the filter support having a portion configured to engage with a portion of the filter module to inhibit the filter module from being separated from the housing.

The filter support may include: a support plate; an elastic member comprising an elastic material configured to apply elastic force to the support plate and to press the filter module against an upper circumference of the filter coupling opening; and a filter catching portion protruding from the support plate and configured to catch with a portion of the filter module.

The second plate may include a second plate opening corresponding to the first plate opening, and a circumference of the second plate opening may be configured to catch with the filter catching portion to inhibit the filter module from being separated from the housing.

The first filter portion may include a plurality of crest portions formed toward an outside of the filter module and a plurality of trough portions formed toward an inside of the filter module.

An air cleaner according to an example embodiment includes: a housing including an inlet and an outlet; a blower fan; a filter module including a first plate, a second plate arranged to face the first plate, and a filter arranged between the first plate and the second plate; and a filter coupling opening configured to couple to or separate the filter module from the inside of the housing, wherein the filter includes a first filter portion configured to filter air passed through the inlet and formed as a single body, and a second filter portion configured to filter air passed through the first filter portion, wherein the second filter portion is separably hooked to at least one of the first plate or the second plate.

The second filter portion includes a plurality of locking hooks arranged to engage with a portion of at least one of the first plate or the second plate, and the at least one of the first plate or the second plate includes a plurality of hook receiving portions arranged to engage with the plurality of locking hooks, and based on the at least one of the first plate or the second plate being separated from the filter, at least one of the plurality of locking hooks or the plurality of hook receiving portions may be arranged to be broken.

The filter may further include a third filter portion arranged on an outer side of the first filter portion and configured to maintain the shape of the first filter portion and configured to allow air introduced from the inlet to be transmitted therethrough toward the first filter portion.

The second filter portion includes a first inner filter, a second inner filter, a third inner filter, and a fourth inner filter, and each of the first inner filter, the second inner filter, the third inner filter, and the fourth inner filter includes a first filter frame, a second filter frame arranged to face the first filter frame, a filter member arranged to be coupled to or separated from the first filter frame and the second filter frame, and a hinge connecting one end of the first filter frame to one end of the second filter frame, wherein the at least one of the first plate or the second plate may further include a hinge receiving portion formed to receive the hinge.

A filter module according to an example embodiment includes a first plate, a second plate arranged to face the first plate, a first coupling portion formed on at least one of the first plate or the second plate, and a filter arranged between the first plate and the second plate and including a second coupling portion, wherein the first coupling portion further includes a plurality of hook receiving portions configured to engage with a portion of the filter, and the second coupling portion includes a plurality of locking hooks configured to engage with the hook receiving portions, and based on the first coupling portion and the second coupling portion being separated, at least one of the plurality of locking hooks or the plurality of hook receiving portions is configured to be deformed to facilitate separation of the at least one of the first plate or the second plate from the filter.

While the disclosure has been illustrated and described with reference to various example embodiments thereof, it will be understood that the various example embodiments are intended to be illustrative, not limiting. It will be further understood by those skilled in the art that various changes in form and detail may be made without departing from the spirit and scope of the disclosure including the appended claims and their equivalents. It will also be understood that any of the embodiment(s) described herein may be used in conjunction with any other embodiment(s) described herein.

What is claimed is:

1. An air cleaner comprising:
a housing including an inlet and an outlet;
a blower fan; and
a filter module including a first plate, a second plate arranged to face the first plate, a first coupling portion formed on at least one of the first plate or the second plate, and a filter arranged between the first plate and the second plate and including a second coupling portion,
wherein the filter includes:
a first filter portion configured to filter the air introduced from the inlet, and separably coupled to the first plate and the second plate, and
a second filter portion configured to filter the air passed through the first filter portion, and separably coupled to the first plate and the second plate,
wherein the first coupling portion and the second coupling portion are separably coupled to each other.

2. The air cleaner of claim 1, wherein the first plate includes a first plate opening configured to allow air passed through the filter to pass therethrough, and
the first filter portion is arranged in a direction along a circumference of the first plate opening and is formed as a single body.

3. The air cleaner of claim 2, wherein the second filter portion is arranged between the first plate opening and the first filter portion.

4. The air cleaner of claim 3, wherein the first coupling portion includes a hook receiving portion configured to engage with a portion of the filter, and
the second coupling portion includes a locking hook configured to engage with the hook receiving portion.

5. The air cleaner of claim 4, wherein
the locking hook includes a plurality of locking hooks, and
the hook receiving portion includes a plurality of hook receiving portions,
wherein based on the first coupling portion and the second coupling portion being separated, at least one of the plurality of locking hooks or the plurality of hook receiving portions is configured to be deformed such that the at least one of the first plate or the second plate and the filter are separated.

6. The air cleaner of claim 3, wherein the second filter portion includes:
a first filter frame,
a second filter frame arranged to face the first filter frame,
a filter member configured to be coupled to or separated from the first filter frame and the second filter frame, and
a hinge configured to connect one end of the first filter frame and one end of the second filter frame.

7. The air cleaner of claim 6, wherein the first plate further includes a hinge receiving portion formed to receive the hinge.

8. The air cleaner of claim 3, wherein the filter further includes a molding member comprising a molded material configured to couple the first filter portion art to the first plate while coupling the first filter portion to the second plate.

9. The air cleaner of claim 3, wherein the filter further includes a third filter portion arranged on an outer side of the first filter portion and configured to maintain a shape of the first filter portion, the third filter portion is configured to transmit air from the inlet toward the first filter portion.

10. The air cleaner of claim 3, wherein the first coupling portion further includes a locking hook configured to be coupled to the filter, and
the second coupling portion includes a hook receiving portion configured to engage with the locking hook.

11. The air cleaner of claim 3, wherein the housing further includes:
a side panel forming an external appearance, and
a filter coupling opening configured to couple or separate the filter module from an inner side of the side panel as a whole.

12. The air cleaner of claim 11, further comprising a filter support arranged at a lower side of the filter module and configured to support the filter module, wherein a portion of the filter support is configured to catch with a portion of the filter module to inhibit the filter module from being separated from the housing.

13. The air cleaner of claim 12, wherein the filter support includes:
a support plate;
an elastic member comprising an elastic material configured to apply elastic force to the support plate to press the filter module against an upper circumference of the filter coupling opening; and
a filter catching portion protruding from the support plate to catch with a portion of the filter module.

14. The air cleaner of claim 13, wherein the second plate includes a second plate opening corresponding to the first plate opening, and
a circumference of the second plate opening is configured to catch with the filter catching portion to inhibit the filter module from being separated from the housing.

15. The air cleaner of claim 3, wherein the first filter portion includes a plurality of crest portions formed toward an outside of the filter module and a plurality of trough portions formed toward an inside of the filter module.
